(19) United States
(12) Patent Application Publication
(10) Pub. No.: US 2006/0098170 A1
(43) Pub. Date: May 11, 2006

(54) Projection display device with enhanced light utilization efficiency

(75) Inventor: Chin-hsiang Lin, Taichung (TW)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 11/266,266

(22) Filed: Nov. 4, 2005

(30) Foreign Application Priority Data
Nov. 10, 2004 (TW) 093134324

(51) Int. Cl. G03B 21/14

(52) U.S. Cl. 353/84

(57) ABSTRACT

An objection display device (1) includes an illumination portion for providing an illumination light beam, a light separating portion for separating the illumination light beam into a plurality of color light beams (RGB) for being projected onto a reflective display panel (22), and a projection lens (23). The light separating portion includes a rotating color wheel (16) and a reflector (14) disposed parallel with each other. The rotating color wheel is comprised of a plurality of color filters each selectively transmitting a desired color component and reflecting the other color components of the illumination light beam incident on the color wheel at a predetermined angle. The reflected color components are incident on the reflector and reflected back by the reflector to the rotating color wheel for recycling at a given moment. The color components transmitted by corresponding color filters sequentially exit the color wheel via different light paths as color light beams with different wavelengths.

### BACKGROUND OF THE INVENTION

1. Field of the Invention

The present invention relates to a projection display device, and particularly relates to a reflective projection display device with enhanced light utilization efficiency.

2. Description of Prior Art

Currently, rear-projection display technologies mainly include LCD (Liquid Crystal Display), DLP (Digital Light Processing) and LCoS (Liquid Crystal on Silicon). Compared with LCD and DLP technologies, LCoS technology has the advantages of high resolution, high brightness, and simple structure, and also has the potential to yield very low-cost light engines.

LCoS is also referred to as “reflective LCD”, where visible light is focused and reflected on the same side. An LCoS light engine system may be classified into a single-panel architecture and a three-panel architecture. The three-panel architecture splits light into three spatially separate primary color light beams, namely red, green, and blue light beams, which in turn illuminate three separate panels. Each panel separately modulates the red, green, and blue light beams. The light emanating from the panels is then recombined and projected to form a full color image. The three-panel system provides high performance and is thus very suitable for high-end application. However, the incorporation of three panels, light splitting optics, and light recombining optics results in a bulky system size and a high component count, leading to high cost and heavy weight.

The single-panel architecture provides a clear advantage over the three-panel architecture by requiring only one panel for the primary colors-red, green and blue-to create image. An example of a single-panel LCoS light engine is shown in FIG. 1 and is generally designated with reference numeral 9. A rapidly rotating color wheel 90 separates a white light beam from a lamp 98 into red (R), blue (B), and green (G) primary color components. These color components sequentially pass through a relay lens 91, two integrators 92, a polarization conversion system (PCS) 93, a relay lens group 94, a polarization beam splitter (PBS) 95, an LCoS panel 96, and a projection lens 97, whereby these color components are spatially polarized and modulated in response to an image signal generated by a driving program, and thus red, green and blue images are respectively produced. These images are then recombined and projected onto a screen, or alternatively, they are flashed in sequence onto a screen at such a rate that a viewer perceives only a single full-color image. However, although this single panel architecture is small, lightweight, and very inexpensive, it is intrinsically less efficient than the three-panel architecture because two thirds of the visible light from the lamp 98 is wasted due to the color separating of the visible light and time sequencing of the separated primary colors by the rotating color wheel 90. That is, the light utilization efficiency of the single panel architecture is reduced to one third of the visible light when it reaches the LCoS panel 96, and consequently, the image brightness is significantly reduced. Such a low light utilization efficiency will require a brighter light source or lamp, with its accompanying larger power supply, excess heat, larger enclosures and cabinet, all of which raise the cost of the projection system.

To address the above low light utilization efficiency problems, various designs have been proposed. Among these designs, as shown in FIG. 2, U.S. Pat. No. 6,669,343 discloses a projection display device, which is generally designated with reference numeral 8, including a light source 80, two integrators 81, a condenser lens 82, color separating means 83, a PCS 84, a PBS 85, an LCoS panel, 86 and a projection lens 87. A white light beam from the light source 80 passes through dichroic filters 830 and 831 to have the white light separated into three constituent red (R), green (G), and blue (B) color light beams. The color light beams are then provided to corresponding rotating prisms 832, 833 and 834, for sequentially scanning the three color light beams onto the LCoS panel 86 from top to bottom. As the R, G, and B color light beams are simultaneously scanned onto the LCoS panel 86, the light utilization efficiency of this system can reach 100% theoretically. However, since three rotating prisms and a plurality of dichroic filters are required in this system, the assembly and adjustment of the entire system become complicated. Accordingly, although high brightness is ensured, the original advantages of a single-panel LCoS architecture, i.e., simple structure and low cost, are sacrificed in this design.

Another solution is shown in FIG. 3, which is an illustration of a projection display device 7 disclosed in U.S. Pat. No. 6,702,446. The projection display device 7 comprises a light source 70, a condenser lens 71, a light pipe 72, a color wheel 73, control means 74, and an image display system 75. In operation, light from the light source 70 enters the light pipe 72 via an opening in an entrance surface and exits the light pipe 72 via an aperture in an exit surface for being incident on a color filter of the color wheel 73. The color wheel 73 comprises three color filters for correspondingly transmitting red, green, and blue light sequentially when rotated. Suppose at one time point, red light is transmitted through the color wheel 73, and both green and blue light are reflected back to the light pipe 72 via the aperture in the exit surface, the green and blue light will be reflected again by a reflective layer at the entrance surface of the light pipe 72 and exits the aperture in the exit surface for being incident on the color wheel 73 again. However, as the light paths of the red, green, and blue light are divergent paths, the light recycling efficiency cannot reach 100%. Further, since the light velocity is extremely high, when the green and blue light are reflected back to the color wheel 73, the color wheel 73 may not have turned to a color filter corresponding to the green or blue light for transmission. Consequently, light utilization efficiency of this projection display system 7 is still limited.

Therefore, there exits a need for improving the conventional projection display devices, so that the light utilization efficiency thereof is enhanced.

### SUMMARY OF THE INVENTION

Accordingly, the object of the present invention is to provide a projection display device with enhanced light utilization efficiency and thus better image quality.

To achieve the above object of the present invention, an objection display device, which employs a reflective display panel, comprises an illumination portion for providing an illumination light beam, a light separating portion for separating the illumination light beam into a plurality of color light beams with different wavelengths that are projected onto the reflective display panel in different light paths, and a projection lens. The light separating portion comprises a rotating color wheel and a reflector. The rotating color wheel is comprised of a plurality of color filters each of which selectively transmits a desired color component and reflects the other color components of the illumination light beam incident on the color wheel at a predetermined angle. The reflected color components are incident on the reflector and reflected back to the rotating color wheel for recycling, whereby a plurality of light reflection channels corresponding to the reflected color components is formed between the color wheel and the reflector at a given moment. The color components transmitted by corresponding color filters sequentially exit the color wheel via different light paths as color light beams with different wavelengths. These color light beams are sequentially and spacially projected onto the reflective display panel, whereby the reflective display panel is illuminated by a corresponding number of strap-like (belt-like) color images. These color images are projected onto a screen by the projection lens.

The illumination portion includes a light source and a parabola-shaped reflecting member for providing a collimated illumination light beam. The parabola-shaped reflecting member may also be replaced by an ellipsoidal reflecting member, in which case a collimating lens is further required to provide a collimated illumination light beam. Preferably, a light pipe may be employed for receiving and homogenizing the light beam from the light source, whereby a uniformly bright light beam is provided to the collimating lens.

When the display panel is in the form of a reflective liquid crystal display panel (such as an LCoS panel), a PCS is further required in the present projection display device. The PCS is disposed between the color wheel and the reflective display panel for converting the unpolarized color light beams from the color wheel into linearly polarized color light beams which are then passed to the reflective display panel.

The present projection display device further has a PBS that is disposed between the projection lens and the reflective display panel for reflecting the linearly polarized color light beams from the PCS to the reflective display panel.

The PBS may also be disposed between the PCS and the reflective display panel for reflecting polarized color images from the reflective display panel to the projection lens.

### BRIEF DESCRIPTION OF THE DRAWINGS

The present invention may best be understood through the following description with reference to the accompanying drawings, in which:

FIG. 1 is a schematic view of the configuration of a conventional single-panel LCoS projection display device;

FIG. 2 is a schematic view of the configuration of another conventional projection display device;

FIG. 3 is a schematic view of the configuration of a further conventional projection display device;

FIG. 4A is a schematic view showing the configuration of a projection display device in accordance with a first embodiment of the present invention;

FIG. 4B is a schematic view showing the light paths between a PBS and a reflective display panel of the present projection display device shown in FIG. 4A;

FIG. 4C is a schematic view showing the configuration of a projection display device in accordance with a second embodiment of the present invention;

FIG. 4D is a schematic view showing the light paths between a PBS and a reflective display panel of the present projection display device shown in FIG. 4B;

FIG. 5 is a view showing the arrangement of color filters of a color wheel of the present projection display device;

FIGS. 6A-6C show how color light beams illuminating the reflective display panel are scanned in the present projection display device at time T=t1, T=t2 and T=t3, respectively; and

FIGS. 7A-7C respectively show how color light beams illuminating the reflective display panel are scanned in the present projection display device at time T=t1, T=t2 and T=t3, wherein the color light beams are partially overlapped with each other.

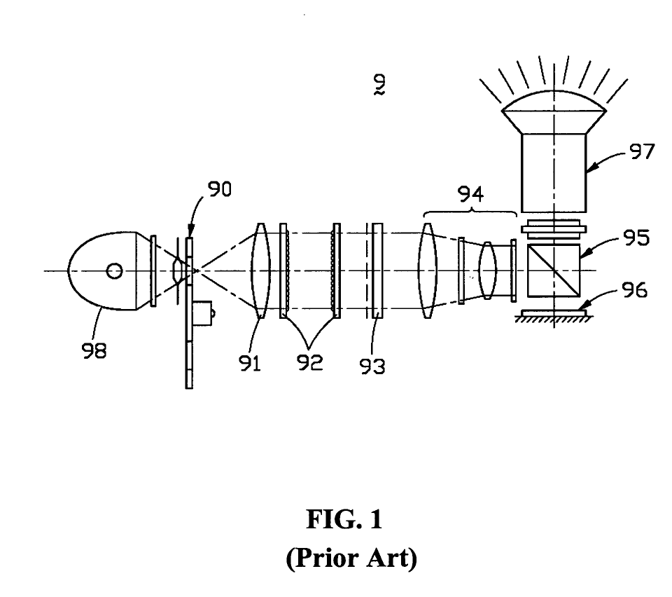

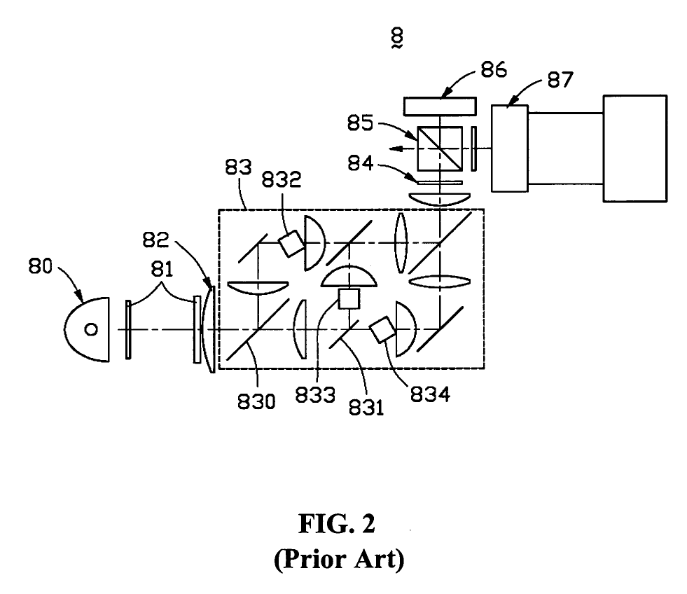

### DETAILED DESCRIPTION OF THE PREFERRED EMBODIMENTS

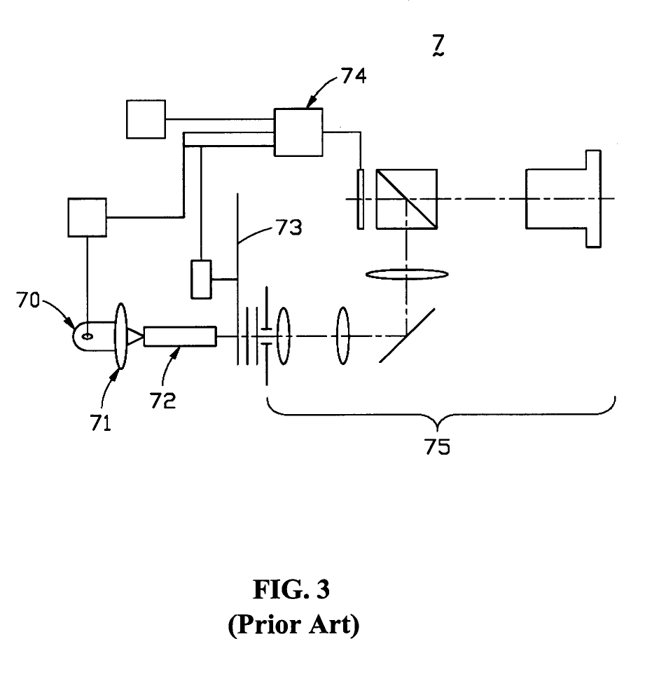

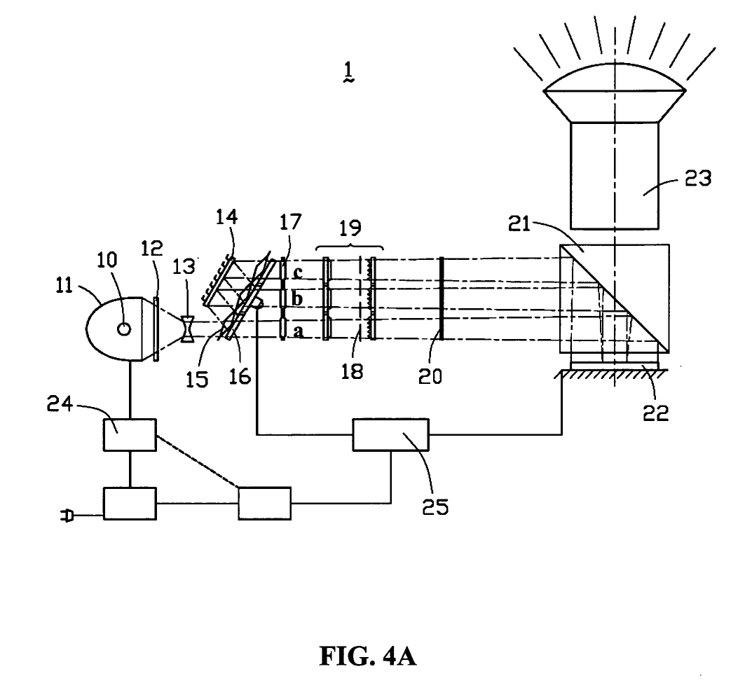

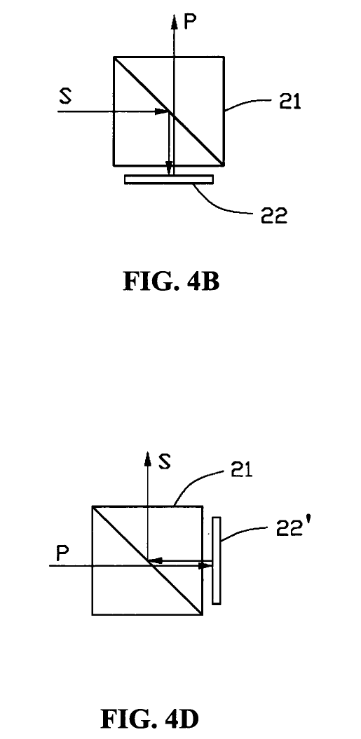

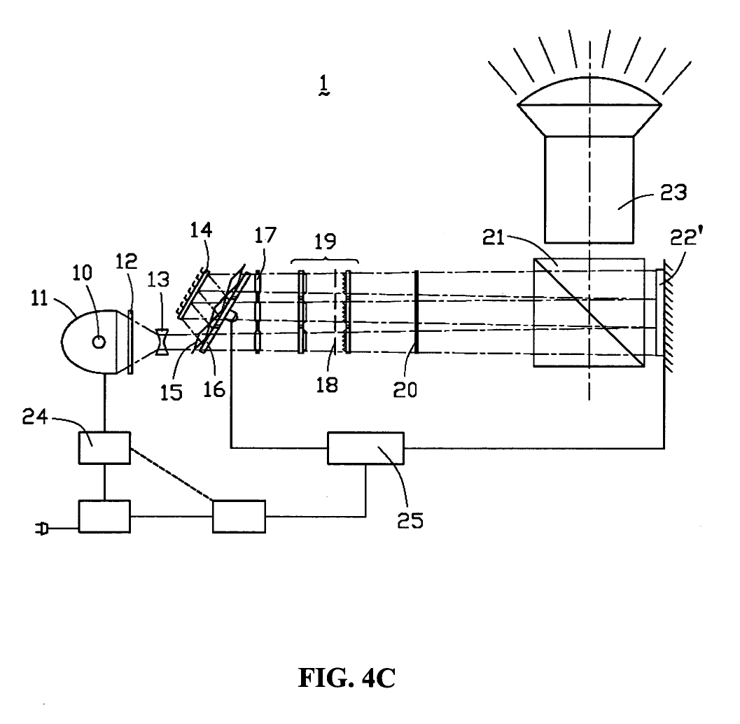

Referring to FIG. 4A, a projection display device 1 in accordance with a first embodiment of the present invention employs a reflective display panel that is preferably an LCoS panel 22. The projection display device 1 comprises an illumination portion, a light separating portion, a polarization conversion portion, an image display portion, and a control portion. The illumination portion is adapted to provide an illumination light beam, and includes a light source 10, a reflecting member 11, an optical filter 12, and a collimating lens 13. The light separating portion is adapted to sequentially separate the illumination light beam into a plurality of color light beams with different wavelengths that are projected onto the LCoS panel 22 in different light paths. The light separating portion preferably includes a reflector 14, a hole grid 15, a rotating color wheel 16, a relay lens 17, a line grid 18, and two integrators 19 each comprised of a lens array. The polarization conversion portion is adapted to convert unpolarized light into linearly polarized light, and includes a PCS (polarization conversion system) 20 and a PBS (polarization beam splitter) 21. The image display portion preferably includes the LCoS panel 22 and a projection lens 23. The control portion is adapted to control the light source 10 and drive the LCoS panel 22, and comprises a light source control device 24 and a panel driving board 25 for driving the LCoS panel 22 to be synchronous with the rotating color wheel 16 and for simultaneously delivering image information to the LCoS panel 22.

The light source 10 may be in the form of a high-voltage discharge lamp that emits white light via glow discharge.

The reflecting member 11 surrounds the light source 10 to intensively direct the white light from the light source 10 to the optical filter 12. The reflecting member 11 may be in the form of a parabola-shaped reflecting member or an ellipsoidal reflecting member. The differences between parabola-shaped and ellipsoidal reflecting members reside in that a parabola-shaped reflecting member allows the white light beam from the light source 10 to be a substantially collimated light beam, while an ellipsoidal reflecting member allows the white light beam from the light source 10 to be a converged light beam. Preferably, the reflecting member 11 is an ellipsoidal reflecting member, in which case a collimating lens 13 is further required to provide a collimated illumination light beam.

The optical filter 12 is a UV-IR filter for intercepting ultraviolet (UV) rays and infrared (IR) light among the white light received from the light source 10 and transmitting a visible light beam.

The white light from the light source 10 is reflected by the ellipsoidal reflecting member 11 to form a converged light beam that is then transmitted through the collimating lens 13 to be a collimated illumination light beam. Preferably, a light pipe, as that shown in FIG. 3 (element 72), may be disposed in front of the collimating lens 13 for receiving and homogenizing the converged light beam from the reflecting member 11, whereby a uniformly bright light beam is provided to the collimating lens 13.

The rotating color wheel 16 is inclinedly disposed on the incident channel of the collimated illumination light beam from the collimating lens 13, and is rotated at a high speed for splitting color components of the illumination light beam from the collimating lens 13. The rotating color wheel 16 is comprised of a plurality of color filters each of which selectively transmits a color component of the illumination light beam having a desired wavelength and reflects the other color components. The reflected color components are incident on the reflector 14 and reflected back by the reflector 14 to the rotating color wheel 16 for recycling, whereby a plurality of light reflection channels corresponding to the reflected color components is formed between the color wheel 16 and the reflector 14 at a given moment. The color components transmitted by corresponding color filters sequentially exit the color wheel 16 via different light paths as color light beams with different wavelengths. As shown in FIG. 4A, an angle is defined between the illumination light beam incident on the color wheel 16 and each reflected light beam. Thus, the white light incident channel and the light reflection channels are formed on the light incident side of the color wheel 16, and the light transmission channels corresponding to the transmitted color light beams are formed on the light transmission side of the color wheel 16. In the preferred embodiment, as illustrated in FIG. 5, the color wheel 16 is divided into three segments each composed of a red (R) color filter, a green (G) color filter and a blue (B) color filter. It is understandable that the color wheel 16 may also be comprised of other desired numbers of segments.

The hole grid 15 is disposed across the light reflection channels between the reflector 14 and the rotating color wheel 16 for shaping the cross-section of the incident illumination light beam, whereby the illumination light beam passing therethrough can be properly projected onto the color wheel 16.

The reflector 14 is a planar mirror disposed on the light reflection channels and parallel with the color wheel 16. The light beams reflected from the color wheel 16 can be reflected back by the reflector 14 to another position of the color wheel 16 along these light reflection channels for light recycling. When the illumination light beam is incident on the color wheel 16 at a predetermined incident angle, one of the color components of the illumination light beam is selectively transmitted through the color wheel 16 by a color filter into a corresponding light transmission channel, and the other color components are reflected back to the reflector 14 by the color wheel 16 via corresponding light reflection channels. These reflected color components are then reflected back again by the reflector 14 to another location corresponding to another color filter of the rotating color wheel 16 for another selective transmission. Consequently, with the rotation of the color wheel 16 and the sequential selective light transmission and reflection, all the color components of the illumination light beam can be finally separated and transmitted by the color wheel 16, whereby a plurality of color light beams with different wavelengths, i.e., red, green and blue light beams in this embodiment, are formed and sequentially transmitted in different light paths. As the light velocity is extremely high, the three primary color light beams are substantially transmitted through the color wheel 16 at the same time point, whereby the light utilization efficiency of the present projection display device can reach 100%.

The relay lens 17, the line grid 18, and the integrators 19 are disposed between the color wheel 16 and the LCoS panel 22 along the light transmission channels of the three primary color light beams for adjusting the distribution of the luminous flux density of the three primary color light beams so that the light energy can be homogeneously distributed. The line grid 18 is adapted to adjust the size of the strap-like (belt-like) color-band regions formed on the LCoS panel 22 by illumination of the primary color light beams, whereby the primary color light beams can be guided for proper projection onto the LCoS panel 22.

The PCS 20 is adapted for converting the unpolarized color light beams from the color wheel 16 into linearly polarized color light beams that are then passed to the LCoS panel 22. In the preferred embodiment, the unpolarized color light beams are converted into S-polarization color light beams for increasing light efficiency.

The PBS 21 is a compound prism composed of two isosceles right-angled prisms with their hypotenuse surfaces cemented with each other. The PBS 21 is disposed between the projection lens 23 and the LCoS panel 22. When an unpolarized light beam is incident on the PBS 21, the S-polarization (perpendicular to the incidence plane) light will be reflected by the PBS 21, and the P-polarization (parallel with the incidence plane) light will be transmitted. Accordingly, after the polarization conversion of the PCS 20, the desired S-polarization light incident on the PBS 21 will be reflected by the PBS 21 to the LCoS panel 22, as illustrated in FIG. 4B. The PBS 21 also serves to separate the light beam incident on the LCoS panel 22 from the reflected light beam.

The LCoS panel 22 is a reflective display panel, and acts as a light valve or a modulator for receiving an incident light and impressing a desired image upon the incident light. The LCoS panel 22 comprises a plurality of pixels formed and arranged therein and is capable of changing the polarization direction of the transmitted light at every pixel aperture by an external signal. Referring to FIG. 4B, when the LCoS panel 22 is in its ON state, the S-polarization light will be switched into a P-polarization light which is then passed through the PBS 21 and enters the projection lens 23. The projection lens 23 magnifies the imaged light and projects the imaged light onto the screen to obtain the desired full color image.

FIG. 4C illustrates a projection display device 1 in accordance with a second embodiment of the present invention. This embodiment differs from the first embodiment shown in FIG. 4A in that the positional relationship between the LCoS panel and the PBS 21 is changed. In this embodiment, the PBS 21 is positioned between the LCoS panel 22′ and the PCS 20. Accordingly, the unpolarized light from the color separating portion is converted into P-polarization light by the PCS 20, rather than into S-polarization light as in the first embodiment. As shown in FIG. 4D, the P-polarization light will be passed through the PBS 21 and into the LCoS panel 22′. After modulation of the LCoS panel 22′, the P-polarization light is switched into S-polarization light which is then reflected by the PBS 21 to the projection lens 23. The projection lens 23 then magnifies the imaged light and projects the imaged light onto the screen to obtain the desired full color image.

The following is a description of how the light beams of individual colors illuminating the LCoS panel 22 are scanned during the rotation of the color wheel 16, with reference to FIGS. 4A, 5 and 6A-6C.

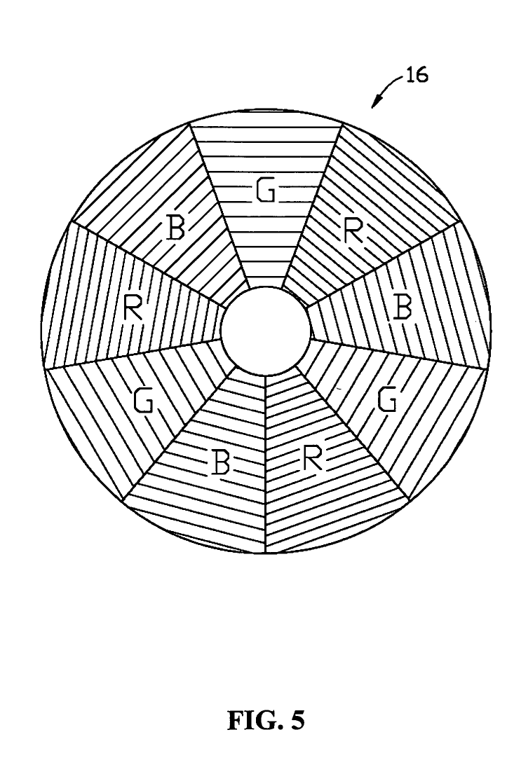

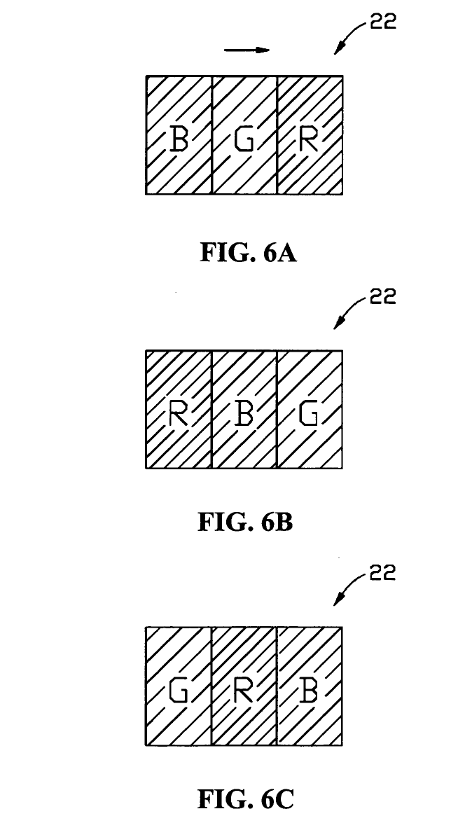

Referring to FIGS. 4A and 5, at a given moment during the rotation of the color wheel 16, the collimated illumination light beam from the illumination portion is incident on one surface of the color wheel 16 on the incident side. Suppose at time T=t1, the illumination light beam is incident on a red color filter (indicated by “R”) on the color wheel 16, the red component of the illumination light beam is transmitted by the red color filter and first exits the color wheel 16 as a red light beam via a first light transmission channel “a” on the transmission side of the color wheel 16. The green and blue components of the illumination light beam are reflected back by the red color filter to the reflector 14 in front of the color wheel 16, and are incident on the color wheel 16 again by the reflection of the reflector 14. With the rotation of the color wheel 16, the green component of the illumination light beam is then transmitted by a green color filter (indicated by “G”) on the color wheel 16 and exits the color wheel 16 via a second light transmission channel “b”. The remaining blue component of the illumination light beam is reflected back again by the green color filter to the reflector 14 and enters the color wheel 16 again by the reflection of the reflector 14. The blue component is finally transmitted by a corresponding blue color filter (indicated by “B”) now in position and exits the color wheel 16 via a third light transmission channel “c”. Therefore, at time T=t1, all the three primary color components, red, green, and blue, of the illumination light beam are sequentially and spatially transmitted through the color wheel 16 via the respective light transmission channels “a”, “b”, and “c”. After passing through the relay lens 17, the integrators 19, the line grid 18, and the PCS 20, the three color light beams of red, green and blue are sequentially incident on the LCoS panel 22. An illumination state of the LCoS panel 22 at time T=t1 is illustrated in FIG. 6A. The color light beams of red, green, and blue via the three light transmission channels illuminate three strap-like (belt-like) regions of the LCoS panel 22 obtained by substantially trisecting an effective region of the LCoS panel 22 in a scanning direction as indicated by the arrow. In other words, as shown in FIG. 6A, the blue, green, and red light beams respectively form a region illuminated by blue light (indicated by “B”), a region illuminated by green light (indicated by “G”) and a region illuminated by red light (indicated by “R”) on the LCoS panel 22 in the order from left to right.

At time T=t2, which is the time the color wheel 16 has been rotated by a predetermined angle from the position at time T=t1, the sequence of the color light beams corresponding to the three light transmission channels “a”, “b”, and “c” has been changed into green-blue-red (GBR). When they are incident on the LCoS panel 22, the illumination state of the LCoS panel 22 is also changed (illustrated in FIG. 6B). It can be seen that, the red, blue, and green light beams respectively form an “R” region, a “B”, region and a “G” region on the LCoS panel 22 in the order from left to right.

Similarly, at time T=t3, which is the time the color wheel 16 has been further rotated by a predetermined angle from the position at time T=t2, the sequence of the color light beams corresponding to the three light transmission channels “a”, “b”, and “c” is further changed into blue-red-green (BRG). The illumination state of the LCoS panel 22 at time T=t3 is illustrated in FIG. 6C. It can be seen that, the green, red, and blue light beams respectively form a “G” region, an “R” region, and a “B” region on the LCoS panel 22 in the order from left to right.

As described above, the belt-like regions illuminated by the light beams of red, green, and blue that are formed on the LCoS panel 22 move sequentially in the scanning direction as indicated by the arrow in FIG. 6A. Although FIGS. 6A to 6C only show the specific time points (time T=t1 to t3) in the above description, because of a continuous rapid rotation of the color wheel 16, each of the regions illuminated by the light beams of the individual colors moves (is scanned) on the LCoS panel 22 continuously rightward (in the scanning direction). When the region illuminated by the light beam reaches the right side, it returns to the left side and moves rightward again.

The time points t1 to t3 described above are switched continuously at a given moment, whereby the three primary color components of the illumination light beam are recombined to obtain a desired full color image. The image is formed by driving each pixel of the LCoS panel 22 by a signal corresponding to the color light beam and modulating the light at every pixel. The light transmitted by the LCoS panel 22 reaches an observer. Since the scanning of the light beams of the individual colors shown in FIGS. 6A to 6C is carried out at a high speed, images of individual colors are synthesized so as to be perceived by a retina of the observer as a full color image that does not appear separately.

As described above, the present projection display device 1 employs a color wheel 16 and a reflector 14 to form a plurality of light reflection channels therebetween. When color components of the illumination light beam from the illumination portion are selectively transmitted and reflected between the color wheel 16 and the reflector 14 through these light reflection channels, a plurality of color light beams (i.e., red, green, and blue light beams), which have different wavelengths and which travel in different light paths, are thus separated from the illumination light beam at a given moment. Accordingly, the light from the light source 10 is fully utilized by the repeated reflection of the reflector 14, whereby the light utilization efficiency of the present projection display device 1 is thus significantly increased and substantially can reach 100%. In addition, since the present invention only employs one rotating element, i.e., the rotating color wheel 16, the configuration of the present projection display device 1 is simplified and the assembly thereof is facilitated.

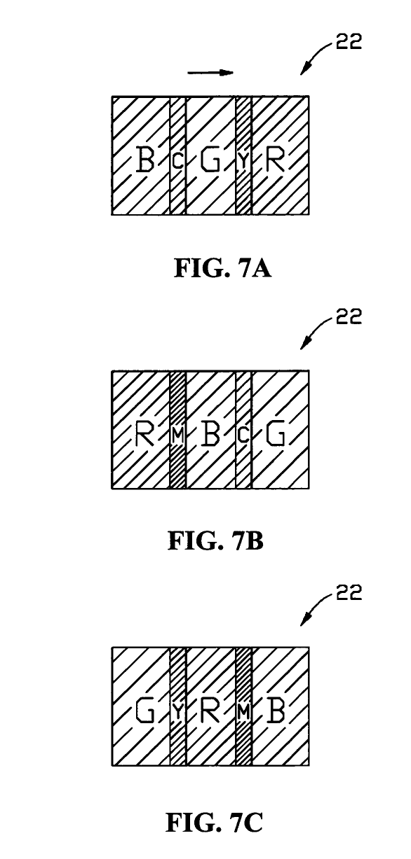

During the scanning of the color light beams on the LCoS panel 22, as shown in FIGS. 7A-7C, interference or overlapping of these primary color light beams may occur, whereby secondary color bands with reduced widths relative to the three primary color bands are formed on the LCoS panel 22. As shown in FIG. 7A, at time T=t1, the green and red lights partially overlap to produce yellow (indicated by “Y”), and the blue and green lights partially overlap to produce cyan (indicated by “C”). When the color wheel 16 is rotated to the position at time T=t2, as shown in FIG. 7B, the red and blue lights partially overlap to yield magenta (indicated by “M”). Similarly, partial overlapping of the primary color light beams to produce secondary color bands also occur at time T=t3, as illustrated in FIG. 7C. These secondary color bands of Y, C, and M each have the same width.

With the continuous rotation of the color wheel 16, the three primary colors of RGB are blended with each other and the three secondary colors of YCM are also blended to yield a vast number of colors. When the black color is desired as the projection color, it only needs to switch the LCoS panel 22 into its OFF state, whereby no light is reflected and the pixels of the LCoS panel 22 appear black.

During the image processing, the panel driving board 25 of the control portion of the present projection display device 1 controls the corresponding pixels of the LCoS panel 22 according to the rotation rate and angle of the color wheel 16 with 256-grayscale level control capabilities. Consequently, the color components of RGB are mixed with each other to produce about 16 million colors, whereby a high quality true color image is provided.

Although an LCoS panel is employed as the image display panel in the above embodiment, it should be understood that, any device is appropriate as long as it is a display device that displays an image by modulating an incident light. For example, the present invention is also applicable to the DLP (Digital Light Processing) display technology. In this case, the LCoS panel will be replaced by an MDM (Digital Micromirror Device) panel, and both the PBS and the PCS are no longer needed. Since the operation principles of the DLP and LCoS technologies are similar, a detailed description thereof is omitted herein.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A projection display device comprising:
a light source providing an illumination light beam;
a rotating color wheel having a plurality of color filters each selectively transmitting a desired color component of the incident illumination light beam and reflecting the other color components of the incident illumination light beam via corresponding light reflection channels, the light reflection channels and the incident channel of the incident illumination light beam being on the same side of the color wheel and a predetermined angle being formed between each light reflection channel and the incident channel of the incident illumination light beam, the color components transmitted by corresponding color filters sequentially exiting the color wheel via corresponding light transmission channels as color light beams with different wavelengths, the light transmission channels being on the other side of the color wheel opposite to the light reflection channels;
a reflector disposed across the light reflection channels for receiving the reflected color components from the color wheel, the reflector reflecting the reflected color components back to the rotating color wheel for recycling, whereby the illumination light beam from the light source is completely transmitted through the rotating color wheel at a given moment as a plurality of color light beams via different light transmission channels;
a reflective display panel receiving the color light beams from the color wheel and forming a plurality of corresponding color-band images thereon; and
a projection lens for projecting the color-band images on an image display region.

2. The projection display device as claimed in claim 1, wherein the color wheel is inclinedly disposed on the incident path of the illumination light beam, and the reflector is disposed parallel with the color wheel.

3. The projection display device as claimed in claim 1 further comprising a PCS disposed between the color wheel and the reflective display panel for converting the unpolarized color light beams from the color wheel into linearly polarized color light beams.

4. The projection display device as claimed in claim 3 further comprising a PBS disposed between the projection lens and the reflective display panel for reflecting the linearly polarized color light beams from the PCS to the reflective display panel and for reflecting the color-band images on the reflective display panel to the projection lens.

5. The projection display device as claimed in claim 3 further comprising a PBS disposed between the PCS and the reflective display panel for reflecting the linearly polarized color light beams from the PCS to the reflective display panel and for reflecting the color-band images on the reflective display panel to the projection lens.

6. The projection display device as claimed in claim 1 further comprising a parabola-shaped reflecting member surrounding the light source for providing a collimated illumination light beam.

7. The projection display device as claimed in claim 1 further comprising an ellipsoidal reflecting member surrounding the light source for converging the light beam from the light source.

8. The projection display device as claimed in claim 7 further comprising a collimating lens for receiving the converged light beam from the ellipsoidal reflecting member to provide a collimated illumination light beam.

9. The projection display device as claimed in claim 1 further comprising an integrator shaping and homogenizing the color light beams from the color wheel before the color light beams enter the reflective display panel, the integrator comprising a lens array.

10. The projection display device as claimed in claim 9 further comprising a hole grid disposed across the light reflection channels for shaping the cross-section of the illumination light beam.

11. The projection display device as claimed in claim 10 further comprising a line grid disposed between the color wheel and the reflective display panel for ensuring proper projection of the color light beams onto the reflective display panel.

12. A projection apparatus comprising:
an illumination module having a light source for providing an illumination light beam;
a light separating module for sequentially separating the illumination light beam into a plurality of color light beams, the light separating portion comprising a rotating color wheel and a reflector, the color wheel having a plurality of color filters each selectively transmitting a desired color component and reflecting the other color components of the illumination light beam incident on the color wheel at a predetermined angle, the reflected color components being incident on the reflector and reflected back by the reflector to the rotating color wheel for recycling, whereby a plurality of light reflection channels corresponding to the reflected color components is formed between the color wheel and the reflector at a given moment, and the color components transmitted by corresponding color filters sequentially exit the color wheel via different light paths as color light beams with different wavelengths;
an image display module comprising a display panel and a projection lens, the display panel receiving and modulating the color light beams from the light separating module to form each color light beam as a color light with a desired image impressed thereupon, the projection lens projecting the image color light onto a desired display region; and
a control module for controlling the light source, the rotation rate of the color wheel and the electrical signal sent to the display panel.

13. The projection apparatus as claimed in claim 12, wherein the rotating color wheel is inclinedly disposed on the incident channel of the illumination light beam, and the reflector is disposed parallel with the color wheel.

14. The projection apparatus as claimed in claim 13, wherein the display panel comprises a reflective display panel.

15. The projection apparatus as claimed in claim 14 further comprising a PCS disposed between the color wheel and the reflective display panel for converting the unpolarized color light beams from the color wheel into linearly polarized color light beams.

16. The projection display device as claimed in claim 15 further comprising a PBS disposed between the projection lens and the reflective display panel for reflecting the linearly polarized color light beams from the PCS to the reflective display panel.

17. The projection display device as claimed in claim 15 further comprising a PBS disposed between the PCS and the reflective display panel for reflecting the polarized image color light from the reflective display panel to the projection lens.

18. The projection display device as claimed in claim 14 further comprising an integrator shaping and homogenizing the color light beams from the light separating module before the color light beams enter the reflective display panel, the integrator being comprised of a lens array.

19. The projection display device as claimed in claim 14 further comprising a hole grid disposed across the light reflection channels for shaping the cross-section of the illumination light beam.

20. The projection display device as claimed in claim 14 further comprising a line grid disposed between the color wheel and the reflective display panel for ensuring proper projection of the color light beams onto the reflective display panel.
